(19) United States
(12) Patent Application Publication
(10) Pub. No.: US 2005/0206513 A1
(43) Pub. Date: Sep. 22, 2005

(54) Voice remote command and control of a mapping security system

(76) Inventor: Kenneth T. Fallon, Las Vegas, NV (US)

Correspondence Address: Kenneth T. Fallon, 10396 Aveburg Manor Lane, Las Vegas, NV, 89135, US

(21) Appl. No.: 10/803,001

(22) Filed: Mar. 17, 2004

(51) Int. Cl. G08B 29/00

(52) U.S. Cl. 340/506; 340/531

(57) ABSTRACT

An invention that enables the use of human speech to remotely access, interrogate, control and obtain real time information from security devices in a facility or location. Wireless, or other network connectivity, mobile devices are used as the voice recognition system. These devices interface to a management system located at the facility or location under surveillance. The user is able to view the mobile display device and command the system using human voice. The system supports detecting and tracking security intrusions, controlling the security devices at the location, requesting changes to the display, obtaining status information of the system or any device, and communicating to others that may be accessing the system jointly. The invention also uses hierarchical maps to quickly identify security problems within an enterprise. The system uses real-time altered icons or element pictures that identify the status of that element at a quick glance. The organized use of hierarchical maps to quickly traverse to and identify particular security problems to include intrusions, alarms, failures, pending failures, etc. Intruder movement is also automatically tracked on or between maps.

### BACKGROUND—FIELD OF INVENTION AND FIGURE DESCRIPTION

The Voice Remote Command and Control of a Mapping Security System is an invention that utilizes computer voice recognition technology to operate mobile devices for managing and responding to a security management system and devices mounted within any facility or location. The user mobile devices may be any device that moves around with an individual or a vehicle. This includes mobile terminals, hand held computers, cell phones, PDAs, etc. By using human speech the user can request information on a network attached security system to obtain security device status, intrusion information, intruder whereabouts, security device failures, video from security cameras, or location maps and floor plans.

The system also utilizes computer displayed topology maps to traverse down and identify a security event (intrusion, device failure, etc.). The system uses a display device such as a computer monitor and an input device such as a computer keyboard although it is not limited to those devices. The system has a topology mapping hierarchy that starts with the highest level map such as a map of the world although it may be any map such as a country, state, province, city, etc. Security sites are shown in their correct location on the highest level map. The user can traverse down the map hierarchy chain by selecting the site and or building and moving down to the next sub map. On site maps facilities and or floor plans are show and floors, or other areas can be shown. Ultimately the mapping traverses down to a floor plan with rooms, computers, people, office equipment, etc. and the location of security devices are overlaid on this lowest level map.

If any security device has failed, is off-line, detected an intrusion, etc. the display picture or icon represents this condition graphically. If a device is down then the facility, building or site display also indicates there is a device down. Users of the system may look at the highest level map or a special facility index page to quickly see if there are any conditions of interest to the security monitor at that level. All identifying pictures of sites, facilities, buildings, locals or floor plans indicate the present security status as part of the display. This allows for quick determination of a problem and the ability to drill down to the proper security device, determine the problem and take action.

This use of hierarchical graphical topology maps to monitor and manage a security enterprise is the key element of this application.

FIG. 1 shows an example of network connectivity to an enterprise security system. Users 100 have access to particular security systems 104 via a wireless network 103 that may include the Internet, an intranet or any dedicated network. By using voice commands (see FIG. 2) the users may manage and control the attached security systems 104 and view necessary information to handle security problems and to generally manage the system.

FIG. 2 illustrates the functions provided by the voice commands.

FIG. 3 shows a list of possible supported equipment.

FIG. 4 shows an example of network connectivity to an enterprise security system. Users 100 have access to particular security systems 103 via a network 101/102 that may include the Internet, an intranet or any dedicated network. By using the mapping scheme they are able to quickly identify problems at any facility 103 and traverse down to the alarming device within that facility.

FIG. 5 illustrates use of the mapping scheme and traversing system.

FIG. 6 shows examples of possible maps.

### BACKGROUND—DESCRIPTION OF PRIOR ART

Prior Art includes patents that set the stage for this patent. They introduce the technology that this patent leverages to produce its innovation. The following patents apply (more detail follows):
1. Vehicle device that recognizes human voice commands
2. Handheld remote computer control and methods for secured interactive real-time telecommunications
3. Audio listen and voice security system
4. Features generation for use in computer network intrusion detection—U.S. Pat. No. 6,671,811
5. Method and apparatus for detecting moving objects, particularly intrusions—U.S. Pat. No. 6,348,863
6. Dynamic software system intrusion detection—U.S. Pat. No. 6,681,331
7. Network-based alert management—U.S. Pat. No. 6,704,874
   1. Vehicle Device That Recognizes Human Voice Commands—U.S. Pat. No. 6,496,107

### Abstract

A vehicle control system for permitting voice control of at least one device in a vehicle by at least one user includes a radio transponder unit which outputs an RF signal which includes an identification code; an electronic receiver for receiving the RF signal and down converting the received signal to output the identification code; a microphone for receiving an audible signal spoken by a user and converting the audible signal to a digital signal; a memory for storing a plurality of files, each file comprising a voiceprint of a user and a command instruction for controlling at least one function of the device; and a microprocessor for determining whether the identification code is valid and for analyzing the digital signal to determine whether it matches one of the voiceprints stored in memory if the identification code is determined valid. The microprocessor executes a command instruction to control the function of the device if a match has been found.

2. Handheld Remote Computer Control and Methods for Secured Interactive Real-Time Telecommunications—U.S. Pat. No. 6,144,848

### Abstract

An interactive bidirectional telecommunication method using a handheld low power user device to access a host computer server along a telecommunication path, and to command the host computer server to transmit audio and/or visual reports to the user device. A system for host computer ordering of consumer products and services using the telecommunications method and handheld low power user device.

3. Audio Listen and Voice Security System—U.S. Pat. No. 5.736,927

### Abstract

An improved voice security system wherein the improvement resides in a non-electrical contact between a remote signalling apparatus and the standard microphone of a two-way radio so that voice transmissions may be accomplished in response to the sensing of a predetermined condition by sensors operatively connected to the remote signalling apparatus. The non-electrical contact is accomplished by the use of a voice and key unit which is electrically connected to the remote signalling apparatus and having a microphone holder mounted thereon whereby the standard microphone physically contacts the housing of the voice and key unit. A speaker is mounted within the voice and key unit housing, and the microphone is modified to include a reed switch which is actuated by a coil placed within the voice and key unit housing whereby, upon applying electrical energy to the coil, the reed switch will close to permit the microphone to transmit audio messages generated by the remote signalling apparatus.

4. Features Generation for Use in Computer Network Intrusion Detection—U.S. Pat. No. 6,671,811

### Abstract

Detecting harmful or illegal intrusions into a computer network or into restricted portions of a computer network uses a features generator or builder to generate a feature reflecting changes in user and user group behavior over time. User and user group historical means and standard deviations are used to generate a feature that is not dependent on rigid or static rule sets. These statistical and historical values are calculated by accessing user activity data listing activities performed by users on the computer system. Historical information is then calculated based on the activities performed by users on the computer system. The feature is calculated using the historical information based on the user or group of users activities. The feature is then utilized by a model to obtain a value or score which indicates the likelihood of an intrusion into the computer network. The historical values are adjusted according to shifts in normal behavior of users of the computer system. This allows for calculation of the feature to reflect changing characteristics of the users on the computer system.

5. Method and Apparatus for Detecting Moving Objects, Particularly Intrusions—U.S. Pat. No. 6,348,863

### Abstract

A method and apparatus for detecting for detecting intrusions, such as intrusions through a door or window of a room, in a manner which ignores movements in other adjacent regions, is provided. The method of detecting intrusions with respect to a monitored space includes exposing the monitored space to a passive infrared sensor having a first sensor element generating a positive polarity signal when its field of view senses an infrared-radiating moving object, and a second sensor element generating a negative polarity signal when its field of view senses an infrared-radiating moving object; generating a movement signal consisting of a positive polarity signal and a negative polarity signal when both have been generated within a first time interval such as to indicate the movement of an object within the monitored space; determining from the relative sequential order of the positive polarity signal and negative polarity signal in the movement signal the direction of movement of the detected object, and particularly whether the movement direction is a hostile direction or a friendly direction; and actuating an alarm when the direction of movement of the movement signal is determined to be in the hostile direction, but not when it is determined to be in the friendly direction.

6. Dynamic Software System Intrusion Detection—U.S. Pat. No. 6.681,331

### Abstract

A real-time approach for detecting aberrant modes of system behavior induced by abnormal and unauthorized system activities that are indicative of an intrusive, undesired access of the system. This detection methodology is based on behavioral information obtained from a suitably instrumented computer program as it is executing. The theoretical foundation for the present invention is founded on a study of the internal behavior of the software system. As a software system is executing, it expresses a set of its many functionalities as sequential events. Each of these functionalities has a characteristic set of modules that is executed to implement the functionality. These module sets execute with clearly defined and measurable execution profiles, which change as the executed functionalities change. Over time, the normal behavior of the system will be defined by the boundary of the profiles. An attempt to violate the security of the system will result in behavior that is outside the normal activity of the system and thus result in a perturbation of the system in a manner outside the scope of the normal profiles. Such violations are detected by an analysis and comparison of the profiles generated from an instrumented software system against a set of known intrusion profiles and a varying criterion level of potential new intrusion events.

7. Network-Based Alert Management—U.S. Pat. No. 6,704,874

### Abstract

A method of managing alerts in a network including receiving alerts from network sensors, consolidating the alerts that are indicative of a common incident and generating output reflecting the consolidated alerts.

None of the patents above offer the solution presented in this invention. The concept of using voice to manage security systems is new and is especially useful in law enforcement and guard agencies. By using the invention users are able to access the security system location by human voice while their hands are busy operating a vehicle, holding a weapon or some other activity. The invention also uniquely identifies the use of graphics and specially identified icons to quickly traverse maps to locate and follow intrusions and capture moving video interactively.

### DETAILED DESCRIPTION

Embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured on in terms of the claims.

Voice Security System:

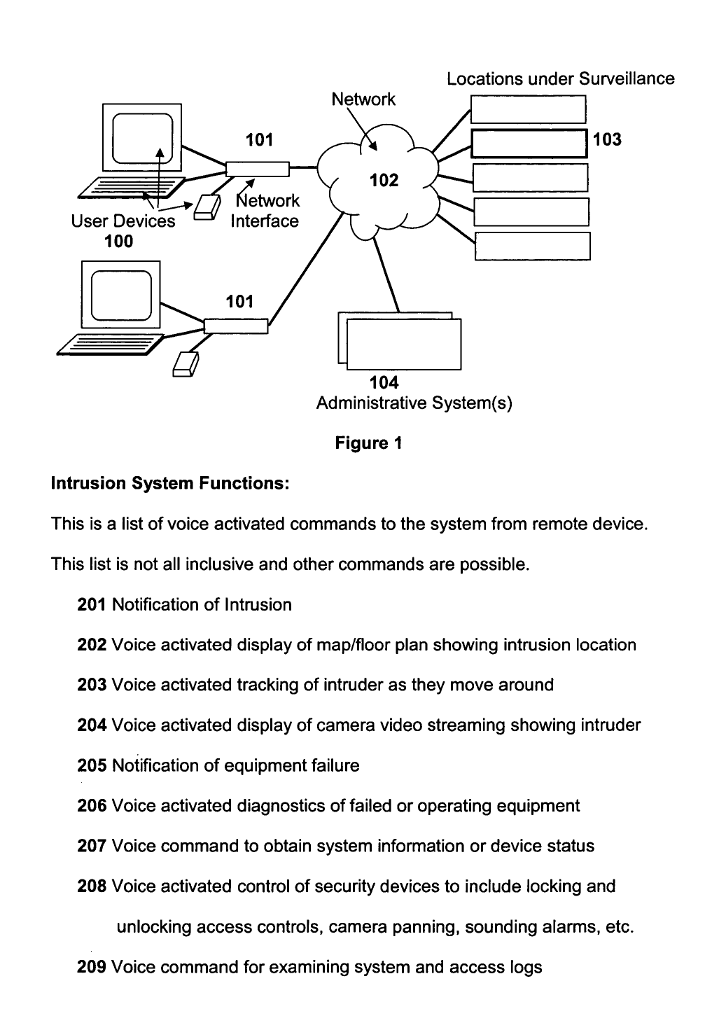

FIG. 1 shows an example of a network that enables the Voice Activation System.
1. User devices 100 command and control the security monitoring system 104 and its devices 103 using voice commands.
2. The commands come across network 101 which normally is a wireless network that interfaces to a backbone network 102 which may be the Internet, intranet or any dedicated type network.
3. Information exchange takes place between users 100, the security devices 103, and the security system 104 controlling the flow across networks 101 and 102.
4. The remote devices 100 respond to human voice commands, format them and send them to the security system controller 104.
5. Information passed back to the devices 100 are displayed in the appropriate format, i.e. cameras display moving images, etc.

Voice Display Functions:

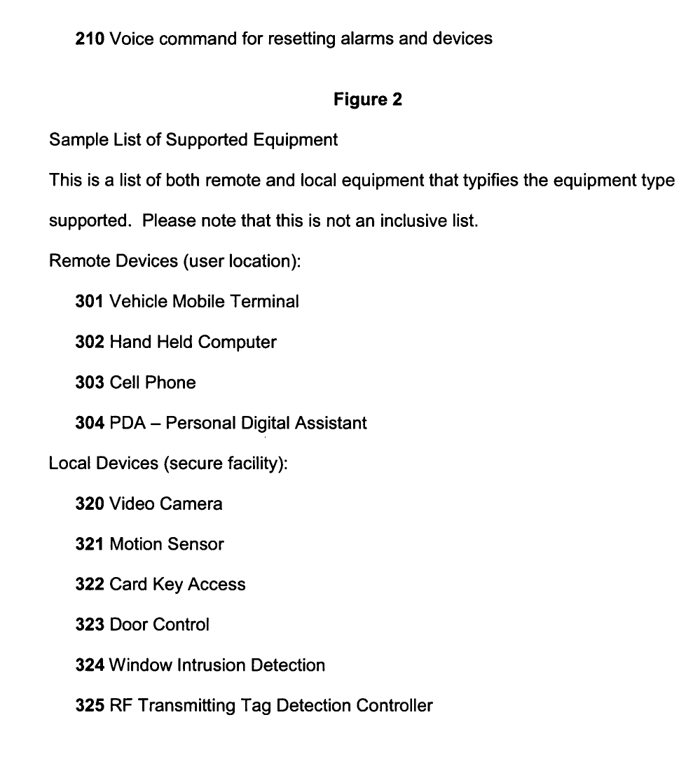

FIG. 2 shows the functions provided through the supported voice commands.
201 Notification of Intrusion
   If an intrusion or other similar notification takes place the user's remote device displays the alert and is in a mode to accept voice commands
202 Voice activated display of map/floor plan showing intrusion location
   A map is displayed on the remote device to allow the ability to locate and narrow in on the alarm
203 Voice activated tracking of intruder as they move around
   When placed in tracking mode by a voice command the location of the intruder is displayed on the map or floor plan and as the movement is tracked on the display
204 Voice activated display of camera video streaming showing intruder
   From voice commands the remote device can display the output of the video cameras at the intrusion location
205 Notification of equipment failure
   By an interrogation voice command all equipment failures are display and voice commands can move between devices
206 Voice activated diagnostics of failed or operating equipment
   Voice commands can run diagnostics on any security device in the system such as cameras, sensors, access detectors, etc.
207 Voice command to obtain system information or device status
   System information can be obtained using voice commands, this includes lists of failed devices, lists of active or inactive devices, scheduling information, etc.
208 Voice activated control of security devices to include locking and unlocking access controls, camera panning, sounding alarms, etc.
   Voice commands can control the characteristics of any device supporting such a feature
209 Voice command for examining system and access logs
   Voice command can list any system log and display the results, this includes sorting, filtering, and selection of records
210 Voice command for resetting alarms and devices
   Voice commands can be used to reset system or device alarms and clear false notifications

System Access Equipment Examples:

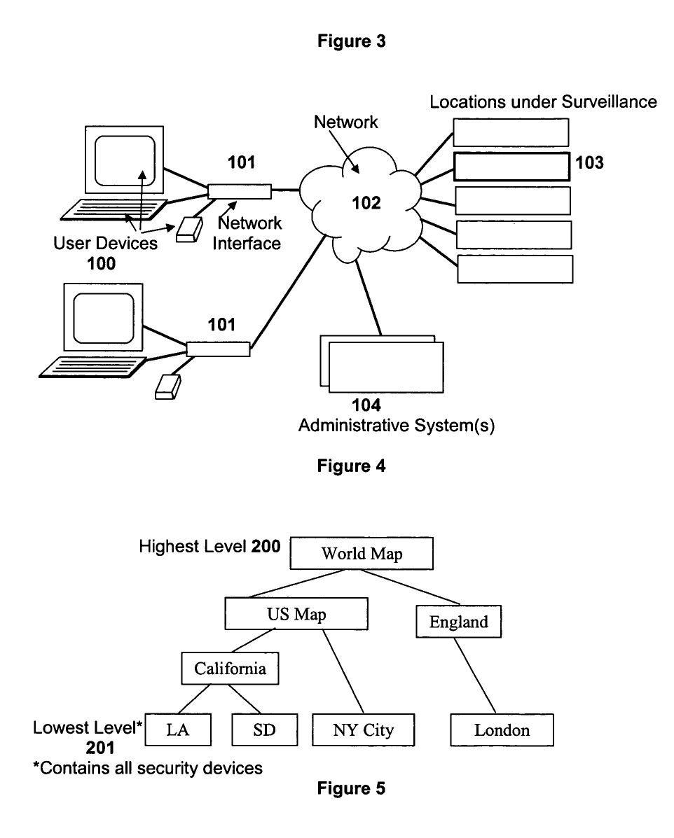

FIG. 3 is a list of typical devices for the remote and local portions of the security system is presented in this table. Remote devices are used to command and control the system through voice and also display the results of the commands such as a video camera stream. The local equipment is the actual security devices at the monitored location to detect intrusions and security violations.

If any security device has failed, is off-line, detected an intrusion, etc. the display picture or icon represents this condition graphically. If a device is down then the facility or site display also indicates there is a device down. Users of the system may look at the highest level map or a special facility index page to quickly see if there are any conditions of interest to the security monitor at that level. All identifying pictures of sites, facilities, buildings, locals or floor plans indicate the present security status as part of the display. This allows for quick determination of a problem and the ability to drill down to the proper security device, determine the problem and take action.

This use of hierarchical graphical topology maps to monitor and manage a security enterprise is the key element of this application.

Retrieving Mapping Information and Maps:

FIG. 4 shows an example of product architecture use of the mapping scheme. Users 100 have the ability to request mapping information from the management system 104 which maps and sends the information as necessary.
1. If it is the lowest map in the hierarchy it will gather security device information from the locations 103.
2. The information is sent across the network 101/102 to the displaying user device 100.
3. The maps hierarchical traversing takes place on command from the user device 100 to the management system 104 and the management system returns the appropriate map in the hierarchy.
4. In addition the management system 104 formats the display to show the status of all elements so any map provides security status of its elements, like sites, facilities, devices, etc.
5. Users at 100 can then traverse down to the lowest map to interrogate the alarm, intrusion or failure. Cameras and sensors can be used t determine what the problem is and to follow the intruder.
6. The management system 104 automatically follows the intruder through and across maps if command to do so.

Mapping Display Functions:

FIG. 5 shows the mapping traversing process. It presents some examples of how the user may set up their mapping hierarchy in a tree view. The system is configurable and the user may set up their maps any way desired. The highest mapping level 200 allows mapping to traverse down to the lowest level 201 which contains the security devices for the enterprise.

System Map Examples:

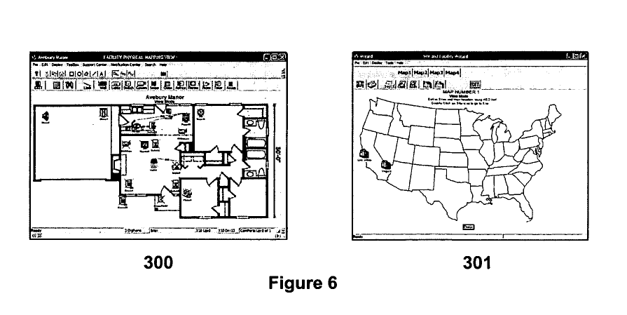

FIG. 6 shows examples of possible maps. These are actual maps themselves for illustration purposes and are not the only choices. Maps themselves are not limited in any way and the user may scan and input other maps, floor plans, pictures, etc. to create the individual maps in the hierarchy. Map 300 is a facility map that displays security devices including sensors, cameras, etc. Map 301 can be either a high level or an intermediate map and is a map of the United States.

1. A system where remote mobile devices recognize human voice and transmits speech commands into a security monitoring system over a network to follow intrusions, activate the system or devices, configure the system, display video information, communicate to others accessing the system and obtain any and all system and device status.
i. Mobile display devices include mobile vehicle terminals, hand held computers, cell phones, PDAs, and all similar remote devices.
ii. Security devices at the location under surveillance are cameras, motion sensors, transmitting card tag systems, open/close switch sensors, window security sensors, and all similar security devices.
iii. Each location under surveillance is controlled by a computer security management monitoring system.
iv. The access is over various network types to include wireless, Internet, intranet, dedicated, etc.

2. A computer system that uses a traversing mapping system to identify and locate security problems at particular locations to include sites, facilities, buildings, rooms, locales, areas, floor plans etc. This allows for quick movement to problems areas and the hierarchy traversing system allows for rapid movement to the failing element.
i. A mapping hierarchy that starts at a high level, like the work map, and identifies sites and from these sites the system will traverse down a tree structure using sub-maps to get to a detailed security location with identified security devices.
ii. A picture status display at every hierarchy level element so that users can identify the level they are at.
iii. A facility index page that shows every security area that has security devices and the status of that facility in the facilities icon or picture.

3. A computer system that uses icons or pictures representing elements such as sites, facilities, locations, floors, rooms, devices, etc. where these icons graphically represent the security status of that location or item. The icon may be the original picture overlaid with a cross out, a warning, or some graphical or text identifier that represent the current security status. If any security device with that location has an abnormal status (such as intrusion, failure, etc.) the location icon will represent that in its picture. By traversing down the security tree the abnormal status can be tracked to the offending device.

4. A computer system that by command automatically tracks intruders on and between maps. Intruders will have their own graphical representation and will be shown overlaid on the maps. The system will automatically display the movement in map windows even if there is more than one intruder on different maps.
